(19) United States
(12) Patent Application Publication
(10) Pub. No.: US 2007/0008259 A1
(43) Pub. Date: Jan. 11, 2007

(54) MODULAR DISPLAY SYSTEM

(76) Inventor: Tom Barker, London (GB)

Correspondence Address: LUEDEKA, NEELY & GRAHAM, P.C., P O BOX 1871, KNOXVILLE, TN, 37901, US

(21) Appl. No.: 11/383,053

(22) Filed: May 12, 2006

(30) Foreign Application Priority Data
Nov. 15, 2004 (WO) PCT/GB04/04832

(51) Int. Cl. G09G 3/34

(52) U.S. Cl. 345/84; 340/815.54; 362/373

(57) ABSTRACT

The present invention provides a modular display system (10) which can be used in a variety of environments for displaying informational signage, advertising, relaying T.V. images, art installations and so on. The system (10) comprises at least one fascia assembly (12) comprising an array of open-ended cells (18) and at least one illumination assembly (14) comprising an array of light sources (32) such as LEDs. Each light source (32) is aligned with a cell (18) and is controlled by a processor (34). Typically, the array of cells (18) is sandwiched between protective front and rear panels (20, 22). A large display may be built up simply and cost-effectively by arranging a number of fascia assemblies (12) together in the desired geometry, with the processors (34) networked together and controlled by an external control processor.

The present invention relates to a modular display system which can be used in a variety of environments for displaying informational signage, advertising, relaying T.V. images, art installations and so on. The modular characteristics provide flexibility in terms of shape and size of the display, to suit a variety of applications.

It is known to provide visual displays made up of an array of pixels, with each pixel being created by a light source such as a light emitting diode (LED), or the end face optical fibre. However, such displays suffer from a number of disadvantages. The angle at which the display can be viewed and the distance from which it can be viewed in order to see a reasonably coherent and legible image are relatively limited. The optical performance and legibility, even when viewed within the preferred ranges, is not particularly great since the image tends to appear as dots of colour on a black background. Such visual displays require additional modification at great expense in order to make them weatherproof for use outdoors and such systems have limited load bearing capacities and cannot be used as structural members.

It is also known to use an array of CRT, plasma or LCD screens covered by thick glass sheets to produce a large display. However, the size and shape of the display is still limited and the overall image produced is disrupted by the relatively thick edges to the individual screens.

A first aspect of the present invention provides a modular display system comprising at least one fascia assembly comprising an array of open-ended cells and at least one illumination assembly comprising an array of light sources, each alignable with a cell of the fascia assembly when in use, and having at least one processor for controlling the light source.

In this way, displays of different shapes and sizes can be conveniently built up from a number of fascia assemblies and illumination assemblies.

Each fascia assembly further comprises front and rear panels which are at least partially light transmitting, between which the array of cells is located.

The front and rear panels provide weatherproofing and in combination with the array of cells improve the stiffness and strength to the whole assembly.

Preferably, the front panel includes a light diffusing layer. This layer may be on a surface of the panel, adjacent to the layer of cells. Preferably the light diffusing layer forms a surface across one open end of each cell which is concave with respect to the front panel.

In a preferred embodiment, the light diffusing layer is formed from synthetic onyx suspended in a resin.

Preferably, a mask is provided at the rear of the array of cells, the mask formed with a plurality of apertures each of which is aligned with a cell.

The mask may comprise an ink silk screen print on a surface of the rear panel. Alternatively, the mask may comprise a perforated sheet located adjacent the rear panel.

In a preferred embodiment the or each fascia assembly is spaced from the or each illumination assembly in use.

In this case, the system preferably comprises cooling means to cool the light sources of the illumination assemblies. This may consist of means to create an air flow through the spacing between the fascia assembly and the illumination assemblies. Alternatively, it may comprise water cooling means adjacent the rear of the or each illumination assembly. Alternatively, it may comprise a thermal bridge between the front of the or each illumination panel and a heat sink adjacent the rear of the or each illumination panel.

Preferably, the array of cells comprises a plurality of rows of cells wherein the cells in each row are offset with respect to the cells in each adjacent row.

Preferably, the cells are hexagonal in shape, in a honeycomb arrangement.

In a preferred embodiment, each fascia assembly has straight edges which intersect the mid point of one row of cells.

However, it is also possible for each fascia assembly to have non-straight edges which follow the perimeter of the cells.

It is also preferred if the light sources of each illumination panel are arranged in a plurality of rows wherein the light sources in each row are offset with respect to the light sources in each adjacent row.

The illumination assemblies may also have straight edges, in which case any light source which would otherwise have been located on an edge is displaced slightly inwardly of the edge of the assembly.

When the display system of the present invention includes more than one processor, the processors are preferably connected to one another by a network, which communicates with a central control processor. The network may be a hierarchical structure or a ring structure.

A further aspect of the present invention provides a modular display system comprising a central controller and a plurality of display modules each having a display area and at least one processor to control the display, wherein the processors are linked together by a network which communicates with the central controller.

Also in the modular display system of the present invention, each fascia assembly may be associated with more than one illumination panel. This is typically preferred when it is desired to have a large display area.

Alternatively, each illumination assembly may be associated with more than one fascia assembly. This may be preferred when an awkward shape of display area is required.

The present invention will now be described in detail, by way of example only, with reference to the accompanying drawings in which:

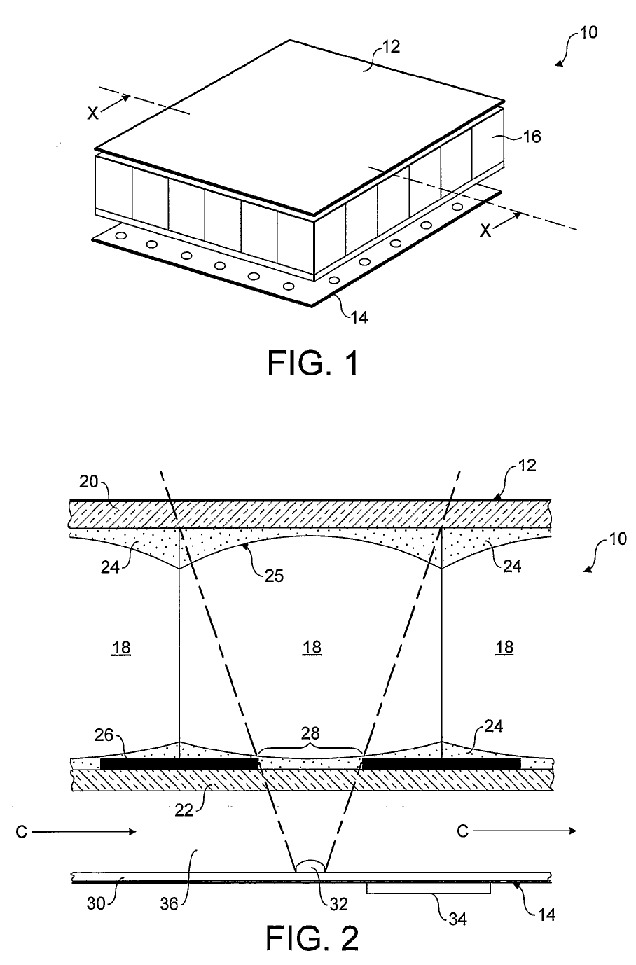

FIG. 1 is a schematic perspective view of a portion of a modular display assembly in accordance with a first embodiment of the present invention;

FIG. 2 is a cross-section of part of FIG. 1 along the line XX;

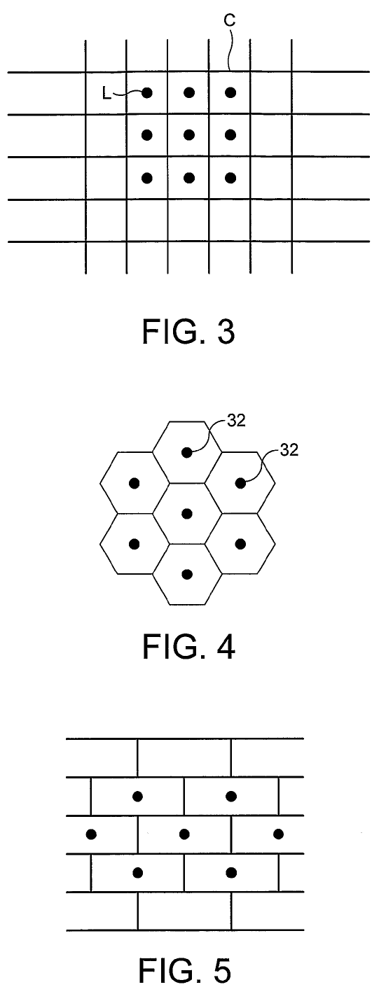

FIG. 3 illustrates a prior art arrangement of light sources on a circuit board with an overlying square grid arrangement of cells;

FIG. 4 is a plan view of an illumination panel in accordance with the invention and overlaid with an arrangement of hexagonal cells;

FIG. 5 is a plan view of an illumination panel in accordance with the invention and overlaid with a rectangular offset arrangement of cells;

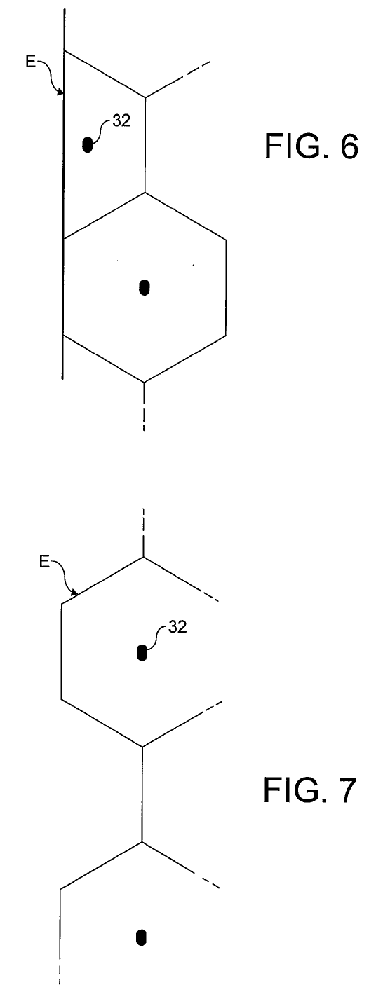

FIG. 6 is a schematic detail view of the edge of a fascia assembly;

FIG. 7 is a schematic detail view of an alternative edge configuration of the fascia assembly;

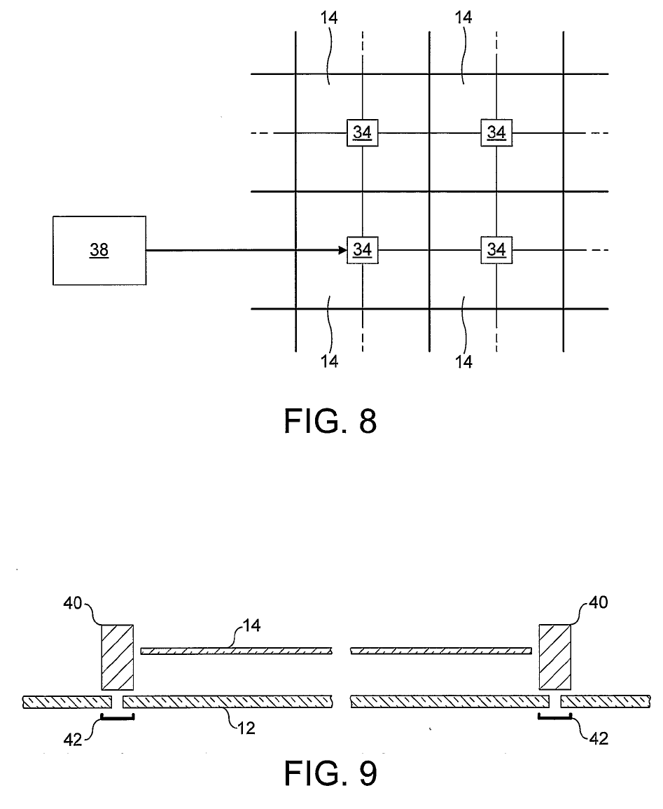

FIG. 8 is a schematic diagram illustrating one embodiment of the control system for the modular display system of the present invention; and

FIG. 9 is a schematic horizontal cross section through part of a display system in accordance with the present invention, incorporated into a conventional glazing system.

FIG. 1 shows a perspective view of a portion of a modular display system in accordance with a first embodiment of the present invention. The system 10 comprises one or more fascia assemblies 12 and one or more illumination assemblies 14. These are essentially self-contained units, manufactured and installed separately. As described further below, each fascia assembly 12 provides an array of cells which are in the form of open-ended tubes through which light can pass. Each illumination assembly 14 comprises a printed circuit board (PCB) carrying an array of discrete light sources, each directing light through one cell, and associated drive circuitry (integrated or otherwise).

The fascia and illumination assemblies 12, 14 are made to a desired convenient unit size and a display can then be built up in multiples of these units. Typically, it may be easier to manufacture and install larger fascia panels with a greater number of smaller illumination panels. For example, for a very large system where a display area of 2.4 m by 2.7 m is required, fascia assemblies may be made with a unit size of 2.4 m×0.9 m, thus requiring three units for the full display area. However, the illumination assemblies may be smaller units, for example 0.6 m×0.9 m and thus each fascia assembly requires four illumination assemblies. However, for a smaller or irregularly shaped display area it may be more convenient to have smaller fascia assemblies cut to a specific shape, for example to provide curved edges to a display area, whereby one illumination assembly serves a number of fascia assemblies.

Each fascia assembly 12 itself comprises an array 16 of cells 18, which are open at each end, sandwiched between protective front and rear panels 20 and 22.

In a preferred embodiment, the array 16 comprises a honeycomb mesh, for example made of aluminium, providing a plurality of hexagonal cells 18. However, the array 16 may be formed of cells 18 of other shapes such as equilateral triangles, squares or rectangles in a grid pattern or an offset brick pattern, circular and so on.

During manufacture a suitable mesh may be stretched by pressing it over a former to ensure the cells 18 are evenly shaped and the array 16 is not distorted.

The front and rear panels 20 and 22 are preferably made of the same material to avoid any thermal distortion effects in use, although in certain applications different materials may be desired. The panels 20, 22 need to be at least translucent and preferably transparent, as well as stiff and strong to provide structural rigidity to the fascia assembly 12. Therefore, they are preferably formed from material such as polycarbonate or toughened glass, typically in the order of 5 mm thick. The array 16 is in the order of 10 to 25 mm thick such that the whole fascia assembly 12 is in the order of 20 to 35 mm thick.

The front and rear panels 20, 22 are secured to the array 16, preferably by adhesive 24. This may be a sprayed or rolled-on wet adhesive or a thin film adhesive sheet. The surface of the front panel 20 adjacent the array 16 is preferably provided with a light diffusing layer to diffuse light which passes through the fascia assembly 12 from the illumination assembly 14. In a preferred embodiment, the light diffusing layer is formed of synthetic onyx suspended in a resin, such as an acrylic resin, an epoxy resin, a polyester resin or a UV cured resin. The light diffusing layer may be applied separately to the adhesive or the two may be mixed first and then applied to the front panel 20.

During manufacture, the array 16 is pressed down onto the front panel 20 and in so doing the diffusion/adhesive layer 24 forms a slight meniscus 25, i.e. a surface which is typically concave with respect to the front panel 20, and which extends across the end of each cell 18. This creates a form of lens which further diffuses light passing through the cell 18. However, the surface of the light diffusing layer may be flat, convex or some other complex surface shape.

As described further below, the illumination assembly 14 provides a plurality of discrete light sources, each of which is aligned with a cell 18 of the fascia assembly 12 in the finished display system. To prevent, or to reduce the amount of, any light bleeding from one cell to adjacent cells it is preferred to provide a mask 26 between the rear sheet 22 and the array 16.

This mask 26 may be in a form of an ink silk screen print on the surface of the rear panel 22 which is adjacent to the array 16, with apertures 28 in the ink layer aligned with each cell 18. The ink is preferably black, but could be another dark colour. Black ensures a good contrast, giving a cell a black appearance when that cell's light source is switched off. Other dark colours will also achieve a good contrast but will give the display a different coloured appearance when the light sources are switched off.

Alternatively, the mask 26 could be a separate sheet of perforated material located adjacent the rear panel 22 (either between the panel 22 and the array 16, or adjacent the outside of the rear panel 22) and having apertures 28 aligned with each cell 18.

Preferably, the apertures 28 are circular although other shapes could be used. The diameter of each aperture 28 may be selected to maximise the amount of light from the light source entering the cell 18 and hitting the light diffusing layer, whilst preventing light from one light source entering an adjacent cell. In this case, the mask 26 is preferably arranged so that the beam of light passing through the aperture 28 fills the front end face of the cell 18, i.e. the area shown between arrows A in FIG. 2.

Alternatively, the apertures 28 may be sized to deliberately allow some light to bleed into adjacent cells 18. The reason for this is that if one light source fails, its associated cell will appear black (or at least dark) and this “dead cell” may be unsightly in the overall display. By allowing some light bleed between adjacent cells this effect is mitigated because some light still passes through the dead cell and it does not look so dark. The light coming from the adjacent cells typically provides a reasonable approximation of the colour the dead cell should have been. This makes any dead cells less obvious and softens cell edges by providing a degree of colour mixing. Nevertheless, the diameter of the apertures 28, and hence the amount of light bleed, should not be too great in case a light source is actually intended to be off to provide a dark cell.

The walls of each cell 18 may be shiny and highly reflective, or may be blackened and non-reflective. Using reflective walls provides a high angle of visibility to the display, almost to 180°, so that the displayed images can be seen clearly by an observer standing well to one side of the display as well as an observer facing the display head on. Using non-reflective walls gives higher contrast between cells 18. This reduces the brightness of the display; this leads to a smaller viewing angle but gives a clearer image with better definition.

Each illumination assembly 14 comprises a circuit board 30 carrying an array of discrete light sources 32, preferably LEDs, but optionally OLEDs, lightbulbs, or other discrete light sources and processing means 34 for controlling the light sources 32.

Each light source 32 may be a surface mounted full colour LED i.e. a combined unit usually having one red, one green and two blue light emitting sources which is able to produce white light in combination, or separate red, green or blue LEDs in a tight cluster. Alternatively, single colour or white LEDs could be used, to provide a monochrome display.

In known light source arrays the light sources L are generally arranged in a square grid pattern as illustrated in FIG. 3. In order to provide a light source aligned with each cell, this square grid arrangement only permits a similar square grid arrangement of cells C as shown in FIG. 3. The cells are shown square but could be hexagonal or rectangular or circular, etc.

However, in the present invention, the light sources 32 are arranged in an offset pattern as illustrated in FIGS. 4 and 5. In other words, the light sources 32 are in rows, with those in each row offset with respect to the light sources 32 in each adjacent row. This permits a correspondingly offset arrangement of cells 18 such as the honeycomb or brick arrangements also shown in FIGS. 4 and 5. In this way each cell 18 has a greater number of directly equidistant adjacent cells, i.e. 6 in FIGS. 4 and 5 compared with only 4 in FIG. 3. This allows better mapping of images onto display and results in images of better effective resolution to the observer.

To provide a large display area, it is of course desirable that the image is coherent across the whole display area and is not disrupted by the edges of multiple units making up the display. The construction of the fascia assemblies 12 and illumination assemblies 14 of the present invention allows effectively seamless joints, and thus continuity of the image.

If a hexagonal array 16 of cells 18 is provided, this can be achieved most simply by forming a straight edge E to each fascia assembly 12 which intersects the mid point of a row of cells 18, passing through opposite vertices, as shown in FIG. 6. Thus, when two light panels abut one another, each bisected cell of one assembly is combined with a bisected cell of an adjacent assembly to reform a single hexagonal cell.

Similarly, the illumination assemblies are most conveniently formed with straight edges. In this case, any light source 32 which would otherwise have been directly on the edge of one of the circuit boards 30 (and aligned with the centre of an overlying cell which is now bisected) must instead be located slightly inwardly of the edge. Therefore, it will be associated with one overlying half-cell and thus slightly off centre within the resultant combined cell 18. (The adjacent circuit board 30 does not then require a light source 32 to be associated with the other half-cell). This has no significant deleterious effect on the quality of the image produced. The apertures 28 in the mask 26 at the edges of the assembly will also be offset so that they are centred on the light source 32.

It is also possible to have straight edges which do not exactly bisect cells, but cut the cells in unequal portions. This may entail shifting the position of the light sources 32 and the mask apertures 28 at the edges to ensure appropriate alignment with the combination cells formed where two fascia assemblies 12 abut.

An alternative embodiment is shown in FIG. 7. Here the edge E of the fascia assembly 12 follows the perimeter of the cells 18 and thus the edge E is castellated to retain whole cells, and adjacent panels interlock one another.

The illumination assemblies 14 could also be formed with correspondingly castellated edges in which case light sources 32 around the perimeter can remain centrally aligned with respect to the overlying cells.

When fascia and illumination assemblies 12, 14 are installed to create a display system, an air gap 36 of typically 5 mm is left between the rear sheet 22 and the circuit board 30 as shown in FIG. 2. As well as simplifying installation, this gap allows cooling of the illumination assembly 14. Light sources 32 such as LEDs generate significant heat but it is preferred to keep them within a temperature range of approximately 50 to 75° C. to maximise their life. Cooling air can be forced through the gap 36 as shown by arrows C, preferably by a transaxial fan which provides a thin strip of moving air, thus providing cooling exactly where it is required across the face of the LEDs. However, another option is to provide water cooling means located adjacent the rear face of the circuit board 30. As a further option, a thermal bridge may be provided between the illumination assembly and a heat sink provided adjacent the rear face of the circuit board 30.

In use, a number of fascia and illumination assemblies 12, 14 may be built up to create a display which may be a stand alone unit, or a separate assembly for mounting on an existing structure. Alternatively, the display system may be physically incorporated into the structure itself, so that it forms an integral part of, for example, an internal or external wall.

The system is particularly suited to incorporation in a wall of a structure clad in glass panels. As shown in FIG. 9, one or more fascia assemblies 12 can be substituted for one or more conventional glazing panels and mounted in the existing glazing support structure, which may consist of rear support mullions 40 and front cover strips 42. Fascia assemblies 12 may also be incorporated into structures wherein glass panels are bonded by structural adhesive to a mullion or wherein glass panels are attached using hidden fixings that clip onto a bevelled panel edge. The required number of illumination assemblies 14 can be fitted subsequently behind the fascia assemblies 12. In this example, the fascia assemblies 12 will be produced with the same dimensions as the normal glazing panels, while the illumination assemblies 14 are sized to fit between the rear support mullions 40.

To display video images on large displays, a large amount of processing power is required. In the present invention, in order to control the light sources 32 and generate the desired images each illumination assembly 14 is provided with at least one processor 34 typically in the form of a PC with its own operating system, usually mounted behind or on the back of the circuit board 30. At its simplest, processor 34 may be a communications interface to the driver circuits that control the light sources 32. In this instance, complex functions such as image processing will be carried out remotely by a control PC.

In an installed display system of the present invention these processors 34 are networked together and the network is linked to an external control PC 38. Each processor has its own network address. The external control PC 38 may be hardwired to the network or may be connected by an Ethernet connection or suchlike. Thus, all the processors 34 in combination provide the required processing power and this is distributed across the whole display system. In this way, the system is scalable since the larger the display, the more the illumination panels hence the more PCs are provided to ensure the necessary processing power is available, without the need for a single, external, high powered control system which would be considerably more expensive.

This arrangement also allows the geometry of the display to be easily reconfigured. For example, a display which consists of a 3×3 arrangement of fascia assemblies 12 can be reconfigured into a 9×1 arrangement, with the corresponding illumination assemblies rearranged as required and once the central control PC 38 is aware of the network addresses of the individual PCs 34 within the network, the appropriate control can be carried out to provide the desired images on the reconfigured display area.

Thus, the present invention provides a modular display system which is simple and cost effective to manufacture and install, and extremely flexible in terms of size and shape and the location in which it can be used whilst providing high quality imaging.

1. A modular display system comprising at least fascia assembly comprising an array of open-ended cells and at least one illumination assembly comprising an array of light sources, each alignable with a cell of the fascia assembly in use, and a processor for controlling the light sources.

2. A modular display system as claimed in claim 1, wherein the fascia assembly further comprises front and rear panels, which are at least partially light transmitting, between which the array of cells is located.

3. A modular display system as claimed in claim 2, wherein the front panel includes a light diffusing layer.

4. A modular display system as claimed in claim 3, wherein the light diffusing layer is formed on a surface of the front panel, adjacent to the array of cells.

5. A modular display system as claimed in claim 4, wherein the light diffusing layer forms a surface across one open end off each cell which is concave with respect to the front panel.

6. A modular display system as claimed in claim 3, wherein the light diffusing layer comprises synthetic onyx suspended in a resin.

7. A modular display system as claimed in claim 1, wherein a mask is provided at the rear of the array of cells, formed with a plurality of apertures, each of which is associated with a cell.

8. A modular display system as claimed in claim 7, wherein the mask comprises an ink silk screen print on a surface of the rear panel.

9. A modular display system as claimed in claim 7, wherein the mask comprises a perforated sheet located adjacent the rear panel.

10. A modular display system as claimed in claim 1, wherein each fascia assembly is spaced from each illumination assembly in use.

11. A modular display system as claimed in claim 10, further comprising cooling means to cool the light sources.

12. A modular display system as claimed in claim 11, wherein the cooling means comprises means to create air flow through the spacing between each fascia assembly and each illumination assembly.

13. A modular display system as claimed in claim 11, wherein the cooling means comprises water cooling means adjacent the rear of each illumination panel.

14. A modular display system as claimed in claim 11, wherein the cooling means further comprises a thermal bridge between the front of each illumination panel and a heat sink adjacent the rear of each illumination panel.

15. A modular display system as claimed in claim 1, wherein the array of cells comprises a plurality of rows of cells wherein the cells in each row are offset with respect to the cells of each adjacent row.

16. A modular display system as claimed in claim 15, wherein the cells are hexagonal and in a honeycomb arrangement.

17. A modular display system as claimed in claim 15, wherein each fascia assembly has straight edges which intersect the mid point of one row of cells.

18. A modular display system as claimed in claim 15, wherein each fascia assembly has non-straight edges which follow the perimeter of the cells.

19. A modular display system as claimed in claim 15, wherein the light sources are arranged in a plurality of rows and wherein the light sources in each row are offset with respect to the light sources in each adjacent row.

20. A modular display system as claimed in claim 19, wherein each illumination panel has straight edges and wherein any light source which would otherwise have been located along an edge is displaced slightly inwardly of the edge.

21. A modular display system as claimed in claim 1, wherein when the system includes more than one processor, the processors are connected to each other by a network and the network is in communication with a central control processor.

22. A modular assembly as claimed in claim 21, wherein the network has a hierarchical structure.

23. A modular assembly as claimed in claim 21, wherein the network has a ring structure.

24. A modular display system as claimed in claim 1, wherein in use each fascia assembly is associated with more than one illumination assembly.

25. A modular display system as claimed in claim 1, wherein in use each illumination assembly is associated with more than one of the fascia assemblies.

26. A modular display system comprising a central controller and a plurality of display modules each having a display area and at least two processors to control the display, wherein the processors are linked together by a network which communicates with the central controller.

27. (canceled)
